(19) United States
(12) Patent Application Publication
(10) Pub. No.: US 2007/0083870 A1
(43) Pub. Date: Apr. 12, 2007

(54) Methods and apparatus for task sharing among a plurality of processors

(76) Inventor: Tomochika Kanakogi, Austin, TX (US)

Correspondence Address: KAPLAN GILMAN GIBSON & DERNIER L.L.P., 900 ROUTE 9 NORTH, WOODBRIDGE, NJ, 07095, US

(21) Appl. No.: 11/193,708

(22) Filed: Jul. 29, 2005

(51) Int. Cl. G06F 9/46

(52) U.S. Cl. 718/105

(57) ABSTRACT

A method is disclosed which may include issuing a plurality of instructions in a processing pipeline of a first processor within a multiprocessor system; determining whether a second processor in the multiprocessor system is in at least one of a running state and a waiting state; and transferring at least one of the instructions to execution stages of a processing pipeline of the second processor and bypassing at least one earlier stage of the processing pipeline of the second processor, when the second processor is in the waiting state.

### BACKGROUND OF THE INVENTION

The present invention relates to methods and apparatus for managing power consumption in a computing system and/or managing the distribution of computational activity among processors in a multiprocessor computing system.

The increasing clock frequencies and decreasing size of modern microprocessors have generated enormous improvements in computing performance and the convenience of providing such performance within a small footprint. However, these improvements have also led to increased power consumption by the microprocessors. This is particularly true of graphics processors. Such problems are exacerbated where a plurality of processors operate together within a multiprocessor system. Moreover, the burden on a multiprocessor system imposed by high power consumption is greater where the multiprocessor system is battery powered.

Thus, there is a need in the art for a solution to the problem of excessive power consumption in multiprocessor systems.

### SUMMARY OF THE INVENTION

According to one aspect, the invention provides a method, comprising: issuing a plurality of instructions in a processing pipeline of a first processor within a multiprocessor system; determining whether a second processor in the multiprocessor system is in at least one of a running state and a waiting state; and transferring at least one of the instructions to execution stages of a processing pipeline of the second processor and bypassing at least one earlier stage of the processing pipeline of the second processor, when the second processor is in the waiting state. Preferably, the bypassing comprises bypassing at least one of a fetch stage, a decode stage, and an issue stage of the processing pipeline of the second processor. Preferably, the method further comprises selecting, within the processing pipeline of the second processor, between receiving instructions issued from the first processor or receiving instructions issued from the processing pipeline of the second processor. Preferably, the method further comprises generating execution stage results by executing the transferred instructions in the second processor. Preferably, the method further comprises

Returning the execution stage results to the first processor. Preferably, the method further comprises receiving the execution stage results into the register file of the processing pipeline of the first processor. Preferably, the transferring comprises: transferring the instructions only if the first processor is in a running state. Preferably;, the method further comprises: executing instructions in the first processor concurrently with executing the transferred instructions in the second processor. Preferably, the method further comprises reducing an operating frequency of at least a portion of the first processor and of at least a portion of the second processor during the concurrent execution. Preferably, the reducing comprises reducing the operating frequency of the first and second processors by about 50% during the concurrent execution. Preferably, at least one of: the portion of the first processor includes a register file and execution stages of the processing pipeline of the first processor; and the portion of the second processor includes the execution stages of the processing pipeline of the second processor.

Preferably, the method further comprises: transitioning from the running state to the waiting state in a given one of the processors when no instructions remain in the pipeline of the given processor. Preferably, the method further comprises: transitioning from the waiting state to the running state in a given one of the first and second processors when at least one of: a) at least one instruction arrives within a pipeline of the given processor; and b) at least one instruction is transferred to the given processor from the other processor. Preferably, the method further comprises initiating the determining and the transferring by a processor unit (PU) of the multiprocessor system.

According to another aspect, the invention provides a multiprocessor system, comprising: a first processor including a pipeline having at least an instruction issue stage for issuing a plurality of instructions; a second processor including a pipeline having at least an execution stage and at least one earlier stage; a first communication link coupled between the first and second processors such that at least one of the instructions may bypass the at least one earlier stage for execution in the execution stage of the second processor when the second processor is in a waiting state. Preferably, the system further comprises a second communication link coupled between the first and second processors such that execution stage results generated in the second processor may bypass a later stage of the pipeline of the second processor when the second processor is in the waiting state. Preferably, the first communication link enables the at least one instruction to bypass at least one of a fetch stage, a decode stage, and an issue stage of the processing pipeline of the second processor. Preferably, the multiprocessor system is operable to select, within the processing pipeline of the second processor, between receiving instructions issued from the first processor or receiving instructions issued from the processing pipeline of the second processor. Preferably, the multiprocessor system is operable to generate execution stage results in the second processor by executing the at least one instruction. Preferably, the multiprocessor system is operable to return the execution stage results to the first processor. Preferably, the multiprocessor system is operable to receive the execution stage results into a register file of the processing pipeline of the first processor. Preferably, the multiprocessor system is operable to enable the at least one instruction to bypass the earlier stage of the pipeline of the second processor only when the first processor is in a running state. Preferably, the multiprocessor system is operable to execute instructions in the first processor concurrently with the execution in the second processor of the at least one instruction. Preferably, the multiprocessor system is operable to reduce an operating frequency of at least a portion of the first processor and of at least a portion of the second processor during the concurrent execution. Preferably, the reducing comprises reducing the operating frequency of the first and second processors by about 50% during the concurrent execution.

Preferably, at least one of: the portion of the first processor includes a register file and execution stages of the processing pipeline of the first processor; and the portion of the second processor includes the execution stage of the processing pipeline of the second processor. Preferably, the first communication link between the first and second processors is established during a manufacture of the multiprocessor system. Preferably, the first communication link extends from the instruction issue stage of the first processor to the execution stage of the second processor. Preferably, the second communication link extends from the execution stage of the second processor to a register file of the first processor. Preferably, the system further comprises an instruction selection multiplexer, in the second processor, disposed between the first communication link and the execution stage.

Preferably, the instruction selection multiplexer is operable to select between instructions issued from the second processor and instructions transferred along the first communication link. Preferably, the execution stage of the second processor comprises an instruction buffer and at least one execution unit. Preferably, the system further comprises an execution results multiplexer, in the first processor, disposed between second communication link and a register file of the first processor. Preferably, the execution results multiplexer is operable to select between execution stage results generated in the first processor and the execution stage results generated in the second processor.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a diagram illustrating the structure of a multi-processing system having two or more sub-processors (SPUs) that may be used in accordance with one or more aspects of the present invention;

FIG. 2 is a block diagram of one approach to providing parallel processing among two processors in a the multiprocessor system of FIG. 1;

FIG. 3 is a block diagram of two of the processors of the multiprocessor system of FIG. 1 that are connected to enable sharing processing tasks in accordance with one or more embodiments of the present invention;

FIG. 4 is a block diagram of two processors within the multiprocessor system of FIG. 1 that are connected to enable sharing processing tasks therebetween and to enable power conservation within both processors in accordance with one or more embodiments of the present invention;

FIG. 5 is a state diagram showing three states for processors in a multiprocessor system in accordance with one or more embodiments of the present invention;

FIG. 6 is a block diagram of two processors interconnected within a multiprocessor system in accordance with one or more embodiments of the present invention;

FIG. 7 is a flow diagram of a method for having two processors within a multiprocessor system cooperate in accordance with one or more embodiments of the present invention;

FIG. 8 is a data table listing the respective states and modes of four processors in a multiprocessor system in accordance with one or more embodiments of the present invention;

FIG. 9 is a flow diagram for controlling the operating modes of a processor pair including two of the processors listed in the table of FIG. 8 in accordance with one or more embodiments of the present invention;

FIG. 10 is a chart illustrating respective levels of power consumption incurred employing conventional and preferred-embodiment approaches to managing processing activity in a multiprocessor system;

FIG. 11 is a diagram illustrating a preferred processor element (PE) that may be used to implement one or more further aspects of the present invention;

FIG. 12 is a diagram illustrating the structure of an exemplary sub-processing unit (SPU) of the system of FIG. 11 that may be adapted in accordance with one or more further aspects of the present invention; and

FIG. 13 is a diagram illustrating the structure of an exemplary processing unit (PU) of the system of FIG. 11 that may be adapted in accordance with one or more further aspects of the present invention.

### DETAILED DESCRIPTION OF THE PREFERRED EMBODIMENTS

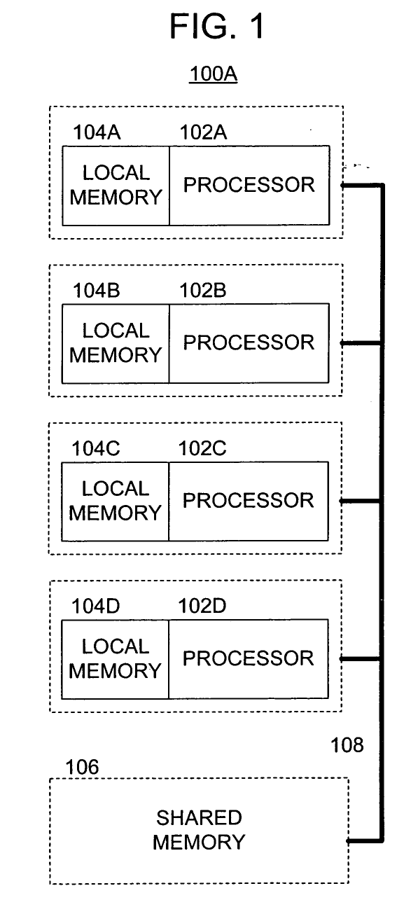

FIG. 1 is a diagram illustrating the structure of a multiprocessor system 100A (also referred to herein as a multiprocessing system) having two or more sub-processors 102. The concepts elsewhere herein may be applied to the multiprocessor system 100A. The system 100A includes a plurality of processors 102A-102D, associated local memories 104A-104D, and a shared memory 106 interconnected by way of bus system 108. Shared memory 106 may also be referred to herein as main memory 106 or system memory 106. Although four processors 102 are illustrated by way of example, any number of processors may be utilized without departing from the spirit and scope of the present invention. The processors 102 may all be of the same construction or may include differing construction.

The local memories 104 are preferably located on the same chip (same semiconductor substrate) as their respective processors 102. However, the local memories 104 are preferably not traditional hardware cache memories in that there are no on-chip or off-chip hardware cache circuits, cache registers, cache memory controllers, etc. to implement a hardware cache memory function.

The processors 102 preferably provide data access requests to copy data (which may include program data) from the system memory 106 over the bus system 108 into their respective local memories 104 for program execution and data manipulation. The mechanism for facilitating data access is preferably implemented utilizing a Direct Memory Access Controller (DMAC) for each processor (not shown). The DMAC of each processor is preferably of substantially the same capabilities as discussed elsewhere herein with respect to other features of the invention.

The system memory 106 is preferably a Dynamic Random Access Memory (DRAM) coupled to the processors 102 through a high bandwidth memory connection (not shown). Additionally or alternatively, DRAM 106 may be connected to processors 102 via bus system 108. Although the system memory 106 is preferably a DRAM, the memory 106 may be implemented using other means, e.g., a Static Random Access Memory (SRAM), a Magnetic Random Access Memory (MRAM), an optical memory, a holographic memory, etc.

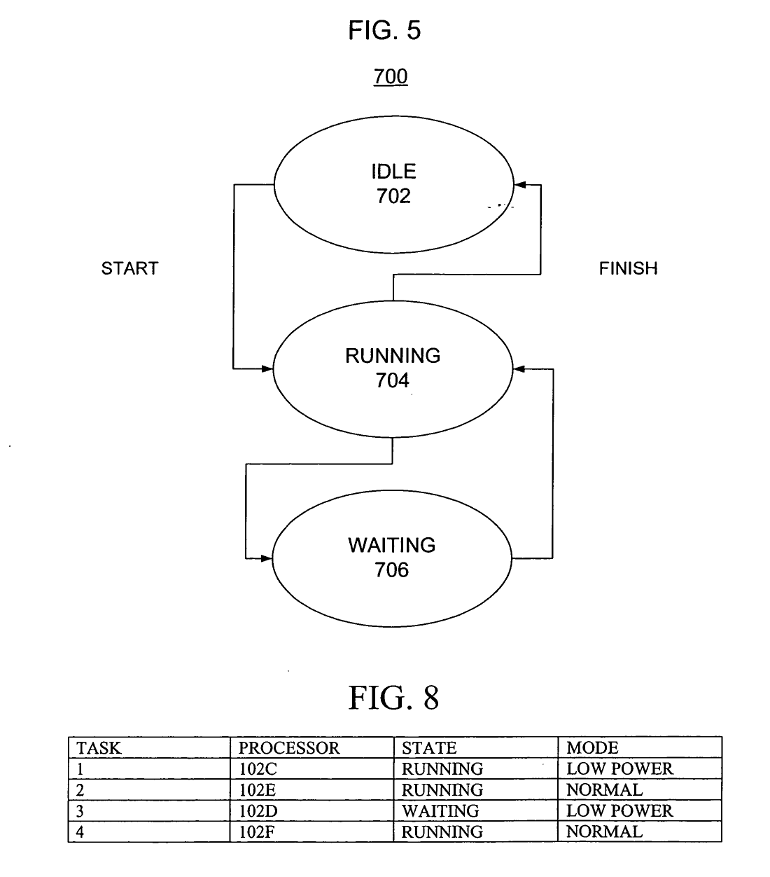

Each processor 102 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processors 102 may include an instruction buffer, instruction decode circuitry, dependency check circuitry, instruction issue circuitry, and execution stages. A specific arrangement of the various processor stages and of the circuitry dedicated thereto, applicable to one or more embodiments of the present invention, is illustrated in FIG. 5 and discussed herein in connection therewith.

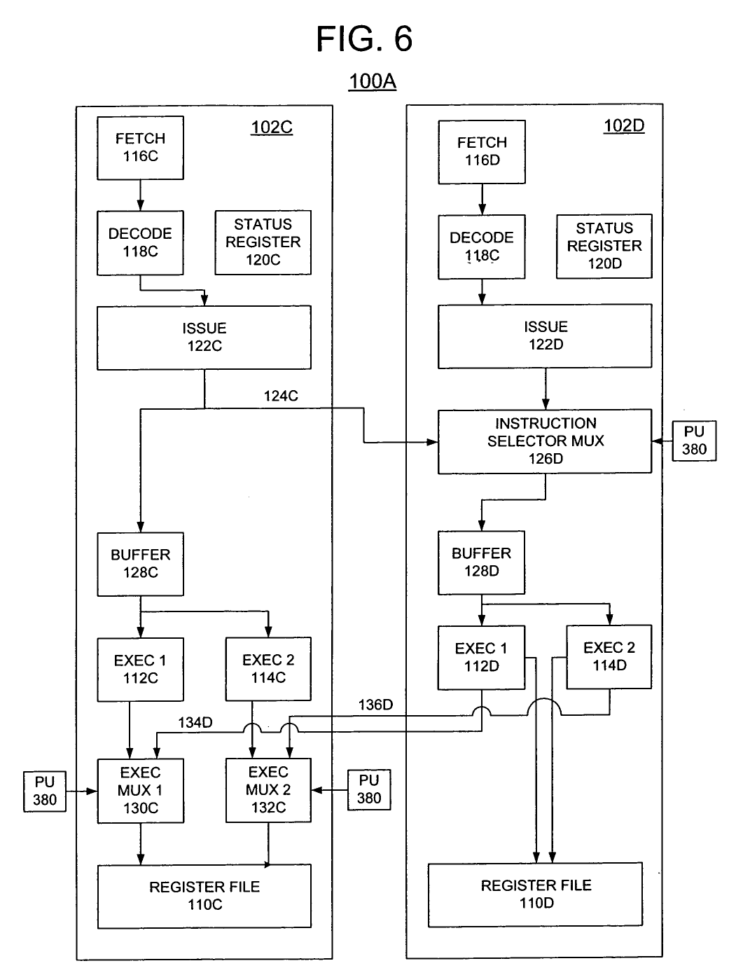

Herein, the term “execution stages” may correspond to one or more execution units of a processor, such as, execution units 112D and 114D of processor 102D (FIG. 6). The “execution stages” may also include an instruction buffer, such as instruction buffer 128D of processor 102D. Herein, the term “execution results” generally corresponds to the term “execution stage results.”

In one or more embodiments, the processors 102 and the local memories 104 may be disposed on a common semiconductor substrate. In one or more further embodiments, the shared memory 106 may also be disposed on the common semiconductor substrate, or it may be separately disposed, such as on a separate semiconductor substrate.

In one or more alternative embodiments, one or more of the processors 102 may operate as a main processor operatively coupled to the other processors 102 and capable of being coupled to the shared memory 106 over the bus 108. The main processor may schedule and orchestrate the processing of data by the other processors 102. Unlike the other processors 102, however, the main processor may be coupled to a hardware cache memory, which is operable cache data obtained from at least one of the shared memory 106 and one or more of the local memories 104 of the processors 102. The main processor may provide data access requests to copy data (which may include program data) from the system memory 106 over the bus 108 into the cache memory for program execution and data manipulation utilizing any of the known techniques, such as DMA techniques.

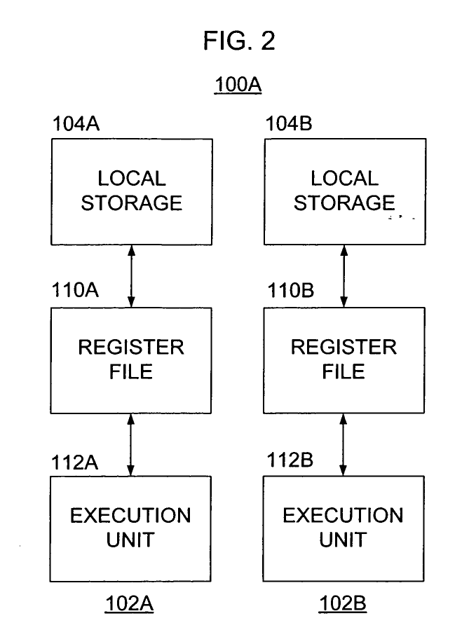

FIG. 2 is a block diagram of one approach for providing parallel processing among two of the processors of multiprocessor system 100A of FIG. 1. Portions of processors 102A and 102B are shown, the processors including respective local storage 104A, 104B, respective register files 110A and 110B, and respective execution units 112A and 112B.

In the multiprocessor system 100A of FIG. 2, in processor 102A, register file 110A may interact with first-processor local storage 102A and execution unit 112A. Likewise, in processor 102B, register file 110B may interact with second-processor local storage 104B, and second-processor execution unit 112B. It is noted that in the system of FIG. 2, once instructions are directed along a processing pipeline of either of the processors, those instructions and any execution results generated therefrom preferably remain within the processor the instructions were initially directed to.

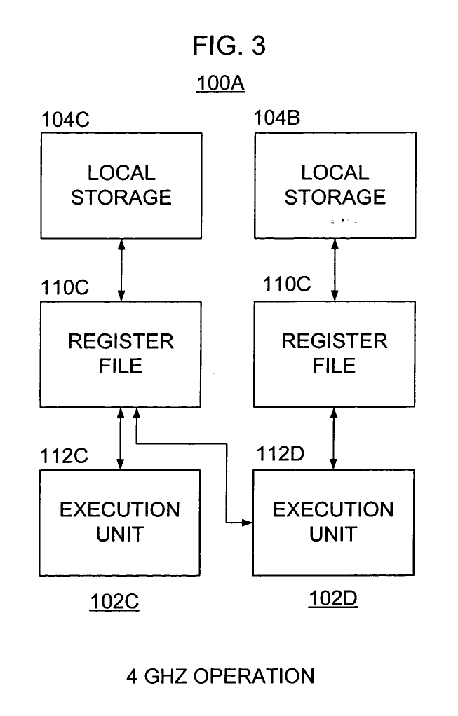

FIG. 3 is a block diagram of processors 102C and 102D that are coupled to enable sharing processing tasks in multiprocessor system 100A of FIG. 1 in accordance with one or more embodiments of the present invention.

In one or more embodiments, including that illustrated in FIG. 3, in contrast with the configuration of FIG. 2, register file 110C of processor 102C is preferably connected to execution unit 112D of processor 102D. Preferably, this connection enables multiprocessor system 100A to transfer instructions from the processing pipeline of processor 102C to that of processor 102D for execution in execution unit 112D. Thereafter, results generated from the execution of the transferred instructions may be returned to register file 110C of processor 102C from execution unit 112D of processor 102D.

In this embodiment, processors 102C and 102D preferably both operate at 4 GHz, as illustrated in FIG. 3. However, other operating frequencies, higher or lower than 4 GHz, may be employed.

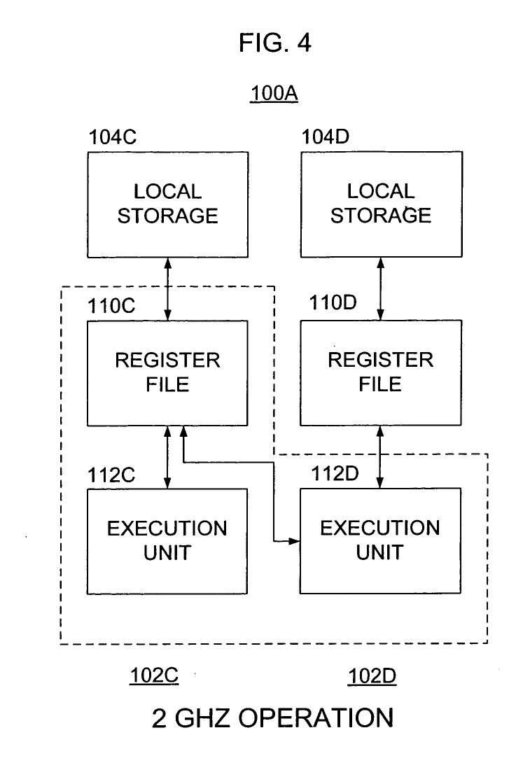

FIG. 4 is a block diagram of multiprocessor system 100A in which processors 102C and 102D are connected together as in the configuration of FIG. 3 to enable the sharing of processing tasks and the conservation of energy in accordance with one or more embodiments of the present invention.

In one or more embodiments, including that shown in FIG. 4, a portion of processor 102C and a portion of processor 102D may operate at frequencies of about 2 GHz while the remainder of processors 102C and 102D may operate at frequencies of about 4 GHz. The components which may operate at the reduced frequency, in one or more embodiments, are shown enclosed within the dashed line in FIG. 4. Preferably, reducing the operating frequency of the components as shown in FIG. 4, operates to reduce power consumption within multiprocessor system 100A. It will be appreciated by those of ordinary skill in the art that the low-frequency region of multiprocessor system 100A may operate at frequencies above or below 2 GHz, and the remainder of multiprocessor system 100A may operate at frequencies above or below 4 GHz.

More generally, the components bounded by the dashed line in FIG. 4 may be caused to operate in a low-power mode, in which one or more power reduction strategies may be employed to reduce power consumption by such components. Those regions not operating within the low-power mode are preferably operating in the “normal mode.” In the normal mode, the operating frequency is preferably about 4 GHz, and the supply voltage is about 1 volt.

One power reduction strategy is the reduction of the operating frequency of the components as discussed above, from about 4 GHz to about 2 GHz. Another power reduction strategy may include reducing the supply voltage to processors 102C and 102D by about 20% of the usual level, or to about 0.8 volts (where the usual supply voltage is about 1 volt). Moreover, in some embodiments, reduction of the operating frequency and reduction of the supply voltage of selected components of processors 102C and 102D may be implemented concurrently, thereby providing still further reductions in power consumption. It is noted that the threshold voltages of transistors within components operating in a low-power mode are preferably increased, thereby reducing the leakage current in these components. The power reduction strategies which may be employed to operate in a low-power mode are not limited to those described above.

It will be appreciated by those of ordinary skill in the art that fewer or more components than those shown surrounded by the dashed line in FIG. 4 may be caused to operate at a reduced frequency and/or at a reduced supply voltage, and all such variations are intended to be included within the scope of the present invention.

FIG. 5 is a state diagram showing three states for processors in multiprocessor system 100A in accordance with one or more embodiments of the present invention. The three states are the idle state 702, the running state 704, and the waiting state 706. The idle state 702 is preferably a sleep mode for a processor, such as processor 102D. The sleep mode is invoked by cutting the supply voltage and/or the system clock to the processor 102 such that substantially no processing or power dissipation is exhibited. The idle state 702 may be invoked by a processor itself or by an external device, such as the main processor (discussed above).

Preferably, in running state 704 of a processor, instructions are being fetched, decoded, and executed in the manner discussed in connection with FIG. 1. Moreover, the pipeline is preferably operating normally while in running state 704. In waiting state 706, a processor is preferably powered with a supply voltage and is preferably receiving a clock signal, but there are generally no instructions awaiting execution in the pipeline of a processor that is in waiting state 706.

In one embodiment, the starting of a processor, such as processor 102D, may cause processor 102D to transition from idle state 702 to running state 704. When processor 102D is finished executing instructions and/or performing other operations, processor 102D may transition from running state 704 to idle state 702. Idle state 702 of a processor may be implemented by cutting the clock signal to the processor, cutting power to the processor, or a combination of the foregoing.

In one or more embodiments, the execution of the last instruction in the pipeline of a processor in running state 704 may cause the processor to transition from running mode 704 to waiting mode 706. Conversely, a processor in waiting mode 706 may transition to running mode 704 once one or more instructions appear in the processor's pipeline.

FIG. 6 is a block diagram showing two processors 102C and 102D and a processor unit (PU) 380 interconnected within multiprocessor system 100A in accordance with one or more embodiments of the present invention. It is noted that multiprocessor system 100A may include processors and/or other devices in addition to those illustrated in FIG. 6. The components of the processing pipelines of processors 102C and 102D illustrated in FIG. 6 differ somewhat from those illustrated in FIGS. 1 and 3. Some conventional components, including the instruction “check” stage, local memory, and shared memory, shown in FIG. 1, are omitted from FIG. 6 for the sake of simplicity. However, such components may be included in one or more embodiments of multiprocessor system 380. Moreover, more detail has been provided regarding the interconnection of processors 102C and 102D than was shown in FIG. 3. However, the power reduction strategies discussed in connection with FIG. 4 may be practiced in connection with multiprocessor system 360 of FIG. 6.

In a preferred embodiment, the interconnections between processors 102C and 102D, discussed below, are employed when both processors are in a cooperation mode, that is, when a master-slave relationship exists, with processor 102C transferring instructions to processor 102D for execution therein.

Thus, in the embodiment of FIG. 6, processor 102C is preferably the “master” processor and processor 102D the “slave” processor, when the processors are in the cooperation mode. However, in one or more alternative embodiments, processor 102D may be a master processor, and processor 102C a slave processor. In still other embodiments, a bi-directional coupling between processors 102C and 102D could enable either processor to be either a master processor or a slave processor.

In one or more alternative embodiments, in which processor 102D may operate as a master processor, additional components may be deployed within processors 102C and/or 102D to enable such operation. Generally, such additional components would be counterparts to components already discussed in connection with multiprocessor system 100A of FIG. 6. Thus, an instruction selector mux 126C (not shown) could be deployed within processor 102C to select between instructions in the processor 102C pipeline and instructions transferred to processor 102C from processor 102D. Moreover, a communication link 124D (not shown) could extend from issue stage 122D to instruction selector mux 126C (not shown).

Likewise, components could be deployed to enable returning execution stage results to processor 102D from processor 102C arising from execution of the instructions transferred from processor 102D. Specifically, execution results multiplexers 130D (not shown) and 132D (not shown) could be deployed within processor 102D. Each of these multiplexers could select between execution results generated from execution units (112D and 114D) in the pipeline of processor 102D and execution results generated in execution units 112C and 114C of processor 102C and subsequently returned to processor 102D. To enable this return of execution results to processor 102D, communication links 134C and 136C could be deployed, with communication link 134C extending from execution unit 112C to mux 130D (not shown) and communication link 136C (not shown) extending from execution unit 114C to execution results mux 132D (not shown). As was discussed earlier in connection with the multiplexers illustrated in FIG. 6, PU 380 could be enabled to control the operation of the additional multiplexers discussed above (the ones not illustrated in FIG. 6). However, other processors could perform this function.

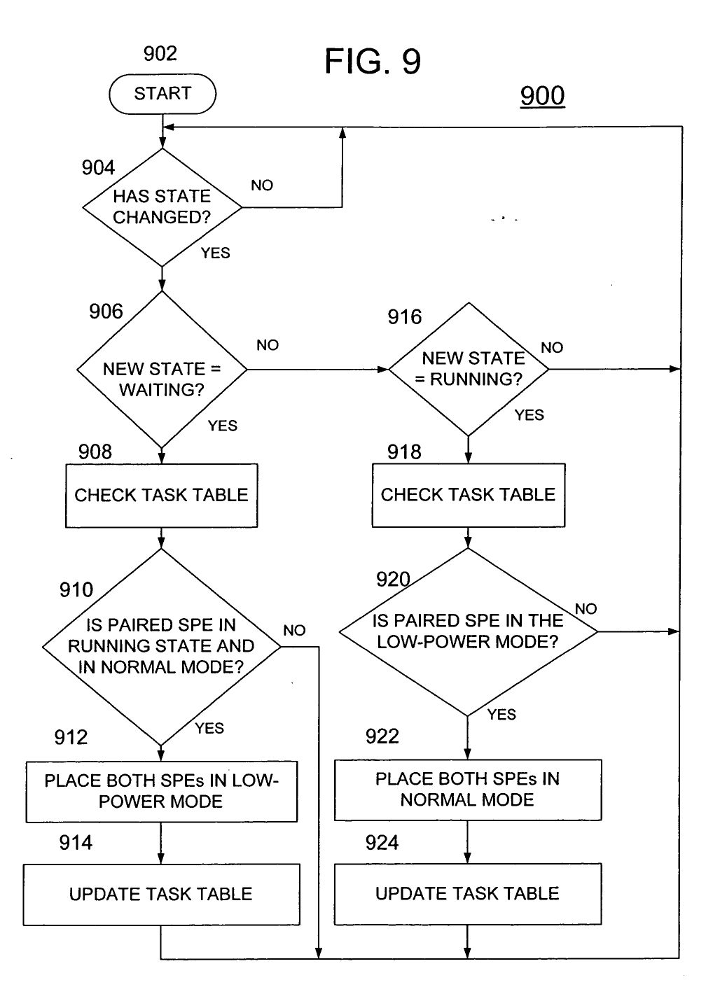

Operation of processors 102C and 102D in the cooperation mode may be accompanied by operation of these processors within a low-power mode, in which one or more of the previously discussed power reduction strategies may be practiced. The method for causing the processors to enter either a normal mode of operation or a low-power mode of operation is discussed further in connection with FIG. 9.

In one or more embodiments, PU 380 may conduct one more detection operations and make one or more decisions relevant to the operation of multiprocessor system 100A. For instance, PU 380 may poll the status of status registers 120C and 120D to determine when conditions are suitable for entry of both processors 102C and 102D into the cooperation mode. PU 380 may also make selection decisions at one or more of multiplexers 126D, 130C, and 132C.

In a preferred embodiment, multiprocessor 100A includes first processor 102C and second processor 102D, each with its respective processing pipeline. Multiprocessor system 100A may also include PU 380. Multiprocessor system 100A may also include one or more additional processors. First processor 102C and second processor 102D may be “paired” within multiprocessor system 100A through the establishment of communication link 124C connected between the two processors. Communication link 124C may be established during the manufacture of multiprocessor system 100A, thereby creating a preferably permanent hardware coupling between first processor 102C and second processor 102D. However, in alternative embodiments, other means of providing for communication between first processor 102C and second processor 102D may be implemented.

Since first processor 102C and second processor 102D preferably include substantially the same components, these components are discussed together in the following, for the sake of brevity. Processors 102C and 102D may include respective status registers 120C and 120D, each of which may indicate one of an idle state 702, a running state 704, or a waiting state 706.

In one or more embodiments, respective processors 102C, 102D may include respective fetch stages 116C and 116D, the function of each of which is preferably substantially the same as that of the fetch stages of the multiprocessor system of FIG. 1. Respective processors 102C, 102D may also include respective decode stages 118C, 118D which receive instructions from the respective fetch stages 116, 116D and which operate much the same way as the decode stages described in connection with the multiprocessor system of FIG. 1. Respective processors 102C, 102D may include respective issue stages 122C, 122D which preferably receive instructions from the decode stages 118C, 118D, respectively.

In one or more embodiments, processors 102D may include instruction selector multiplexer 126D which may receive instructions from issue stages 122C and 122D and which may provide output to instruction buffer 128D.

In a preferred embodiment, communication link 124C may extend from the output of issue stage 122C of first processor 102C to an input of instruction selection mux 126D of second processor 102D.

In one or more embodiments, respective buffers 128C, 128D may be coupled to respective first execution units 112C, 112D and/or to respective second execution units 114C, 114D. In one or more embodiments, the output of first execution unit 112C and second execution unit 114C may be connected to the inputs of execution results multiplexers 130C and 132C, respectively. In one or more embodiments, the outputs of first execution unit 112D and second execution 114D of processor 102D may be connected to second-processor register file 110D. The outputs of first execution results multiplexer 130C and second execution results multiplexer 132C may be coupled to register file 110C.

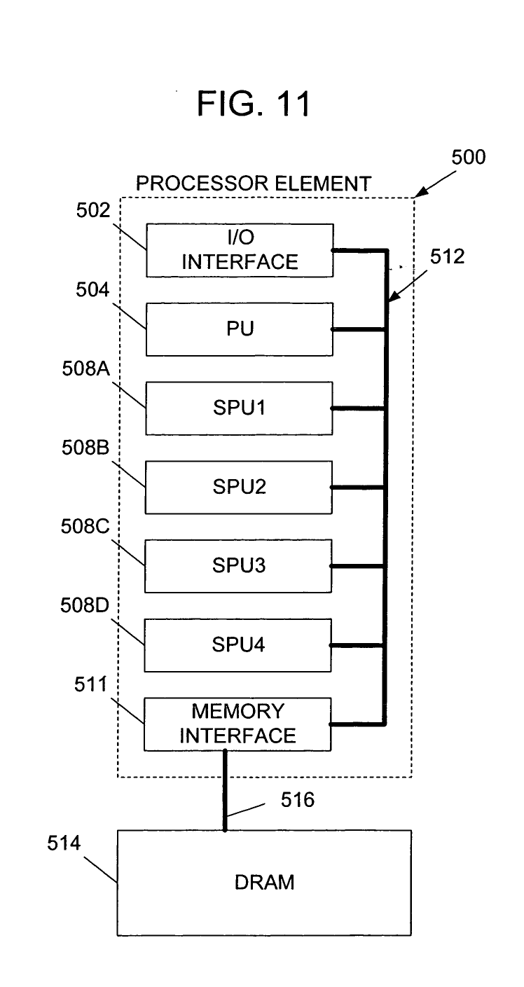

In this embodiment, PU 380 may be coupled (via a hardwired connection or other type of connection) to instruction selector multiplexers 126D, 130C, and 132C to control instruction selection operations therein. PU 380 is illustrated in several locations within FIG. 6 for the sake of convenience. However, in a preferred embodiment, PU 380 is a single device. It will be appreciated that one or more additional PUs, similar to or differing from PU 380, may be deployed within multiprocessor system 100A, and all such variations are intended to be included within the scope of the present invention. PU 380 may be substantially similar to or different from PU 504 which is discussed in connection with FIG. 11 of this disclosure.

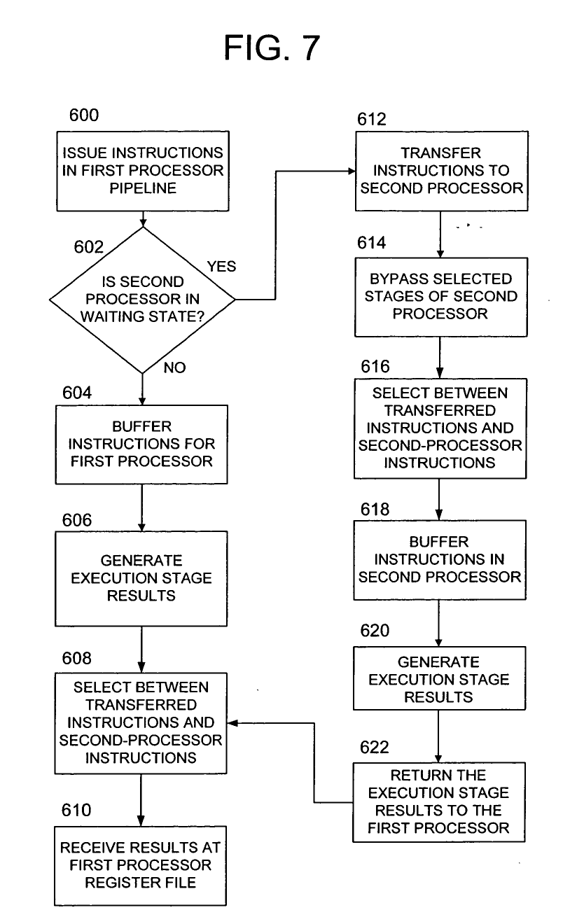

FIG. 7 is a flow diagram of a method for having first processor 102C and second processor 102D of multiprocessor system 100A cooperate in accordance with one or more embodiments of the present invention. The following makes reference to both FIGS. 6 and 7.

At step 600, instructions are preferably issued in issue stage 122C of first processor 102C. At step 602, multiprocessor system 100A preferably determines whether or not second processor 102D is in a waiting state 706. This determination may be made by PU 380. However, other processors may be employed for this purpose.

If second processor 102D is not in waiting state 706, the instructions may be buffered within buffer 128C of first processor 102C (step 604). Thereafter, execution stage results may be generated for the instructions employing one of execution units 112C and 112C (step 606). At step 608, the execution stage results may then be selected in one of execution result multiplexers 130C (for execution results generated in first execution unit 112C) and 132C (for execution results generated in second execution unit 114C). In one or more embodiments, PU 380 may control multiplexers 130C and/or 132C. Thereafter, the execution stage results may be received at register file 110C of first processor 100A (step 610).

Referring back to step 602, if second processor 102D is in waiting state 706, at least one instruction issued in issue stage 122C of first processor 102C may be transferred along communication link 124C to execution stages of the processing pipeline of second processor 102D for processing therein (step 612). The transfer of instructions in step 612 may bypass at least one earlier stage (one stage prior to the execution stages) of the processing pipeline of second processor 102D (step 614).

At step 616, instruction selector multiplexer 410 may be instructed to select between the one or more instructions transferred from first processor 102C and instructions issued in issue stage 122D of second processor 102D. Once instruction selector mux 410 selects the one or more instructions transferred from first processor 102C, the one or more instructions may proceed through instruction selector mux 126D to buffer 128D. The transferred one or more instructions may be buffered in buffer 128D (step 618), after which the one or more instructions may be directed to one of first execution unit 112D and second execution unit 114D. In one or more embodiments, PU 380 may control the selection operations in mux 126D.

At step 620, execution stage results may be generated for the transferred one or more instructions. Thereafter, at step 622, the generated execution stage results for the one or more transferred instructions may be returned to first processor 102C. Specifically, execution stage results for the one or more instructions may be directed along communication link 134D to first execution results multiplexer 130C or along communication link 136D to second execution results multiplexer 132C, both within first processor 102C.

At step 608, one of execution results multiplexers 130C and 132C may be directed to select between the returned execution stage results and execution stage results proceeding along the processing pipeline of first processor 102C. Once one of execution results multiplexers 130C and 132C selects the returned execution stage results, the returned execution stage results may be received at register file 110C (step 610). In one or more embodiments, PU 380 may control the selection operations in multiplexers 130C and 132C.

In one or more embodiments, when first processor 102C and second processor 102D execute instructions concurrently as in the method of FIG. 7, PU 380 may implement one or more power reduction strategies for selected portions of first processor 102C and selected portions of second processor 102D. In one embodiment, during such concurrent execution, all or essentially all of the components of first processor 102C illustrated in FIG. 6 may be subject to one or more power reduction strategies. Moreover, buffer 128D, execution unit 112D, and/or execution unit 114D of second processor 102D may also be subject to the one or more power reduction strategies.

In the foregoing, an embodiment of a method in which first processor 102C uses the execution stages of second processor 102D and then retrieves execution results from second processor 102D has been discussed. In one or more alternative embodiments, second processor 102D could be enabled to similarly use the execution stages of first processor 102C and thereafter retrieve execution stage results from first processor 300. However, for the sake of brevity, a detailed illustration of such alternative-embodiment methods is not included herein.

FIG. 8 is a table listing the states and modes of four processors 102C, 102E, 102D, and 102F operating in accordance with on or more embodiments of the present invention. It is noted that processors 102E and 102F are not shown in the drawings.

In one or more embodiments, processors 102C and 102E may be master processors, and processors 102D and 102F may be subservient processors. While processors 102C and 102E are both in the running state 704, processor 102C is in low-power mode, and processor 102E is in normal mode. This variation is explained by the states of the subservient processors 102D and 102F with which processors 102C and 102E, respectively, may be paired. Specifically, in the table of FIG. 8, processor 102D (the processor paired with processor 102C) is in the waiting state 706, and processor 102F (the processor paired with processor 102E) is in the running state 704. It may also be seen that each processor is in the same operating mode as the processor with which it is paired. Thus, processors 102C and 102D are both in the low-power mode, and processors 102E and 102F are both in the normal mode. Thus, among the combinations presented in FIG. 8, the state of the subservient processor within each processor pair preferably determines the operating mode of the entirety of the processor pair of which it is a part.

A method for controlling the operating mode (i.e. either normal or low-power) of a processor pair in accordance with one or more embodiments of the present invention is described below with reference to FIG. 9. In the following, reference is made to the processor pair illustrated in FIG. 6. However, it is noted that the method described below may be applied to any processor pair consistent with the inventive principles disclosed herein.

Regarding the method of FIG. 9, it is noted that suitable conditions for a processor pair entering a low-power mode may include the master processor of the processor pair being in running state 704 and the slave processor of the processor pair being in waiting state 706.

In the discussion of the following method, the various enquiries and decisions may be made by PU 380. However, in alternative embodiments, the enquiries and decisions may be made by other processing devices in communication with processors 102C and 102D.

The method preferably starts at step 902. Preferably, at step 904, it is determined whether the state of processor 102D has changed. If the state of processor 102D has not changed, the method may repeat step 904. If the state of processor 102D has changed, the method may conduct a sequence of enquiries about the new state.

There are preferably three basic paths from this point forward within method 900. If the new state of processor 102D is neither the waiting state 706, nor the running state 704, as determined in steps 906 and 916, respectively, the method may return to step 904. If the new state of processor 102D is the waiting state 706, the method proceeds to implement at least a portion of steps 908 through 914. If the new state is the running state 704, the method preferably proceeds to implement at least a portion of steps 918 through 924.

If the new state of processor 102D is waiting state 706, the method preferably checks (step 908) the task table of FIG. 8 and preferably determines (step 910) whether processor 102C, with which processor 102D is paired, is in the running state 704 and in normal mode. If processor 102C does not satisfy both of these conditions, the method preferably returns to step 904. If both of these conditions are satisfied, the method may place both of processors 102C and 102D in the low-power mode (step 912) and may update (step 914) the task table of FIG. 8 to suitably reflect the operating mode change.

If the method determines, in step 906, that the new state is not the waiting state 706, and determines, in step 916, that the new state is the running state 704, the method preferably checks the task table (step 918) and preferably determines (step 920) whether processor 102C is in the low-power mode. If processor 102C is not in the low-power mode, the method preferably resumes at step 904. If processor 102C is in the low-power mode, the method preferably places (step 922) the processor 102C-processor 102D processor pair in the normal mode and preferably suitably updates (step 924) the table of FIG. 8. The logic behind the foregoing is that when processor 102D is in the running state 704, the 102C-102D processor pair should not be in the low-power mode. Accordingly, if the method, in step 920, determines that processor 102C is in the low-power mode, the method acts to correct this situation by placing the 102C-102D processor pair in the normal mode in step 922.

In one or more embodiments, the processor-pair task sharing method of FIG. 7 and the processor-pair operating mode control method of FIG. 9 may be practiced concurrently. This concurrent operation is available because the task sharing method of FIG. 6 can preferably be practiced within a processor pair whether the processor pair is operating in the normal mode or in the low-power mode.

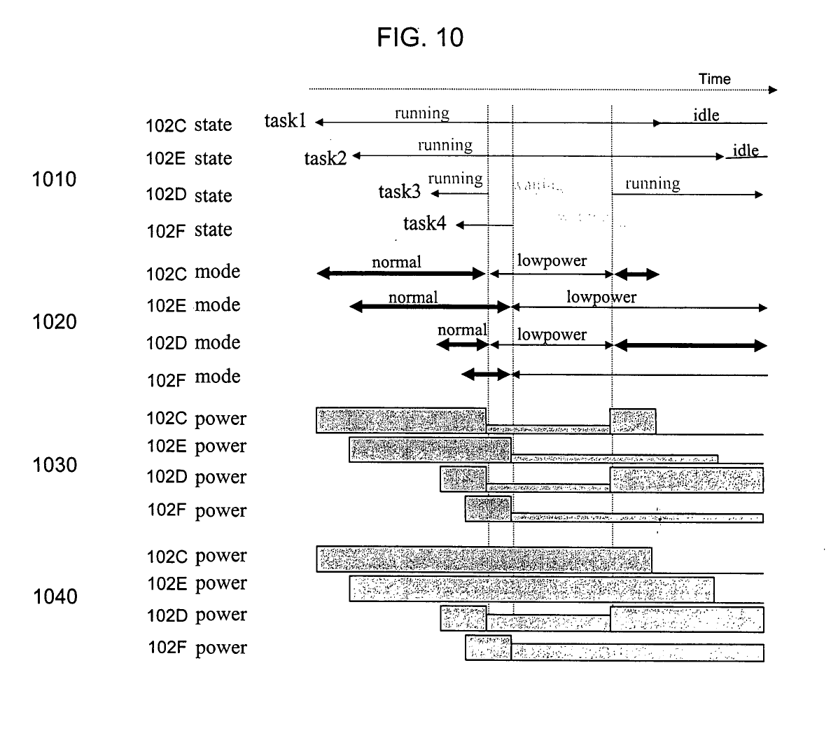

The processor pair operating mode control method discussed above preferably operates to minimize power consumption by placing the 102C-102D processor pair into the low-power mode whenever the states of both processors in the pair warrant this step. The method illustrated in FIG. 9 may be practiced on any desired number of processor pairs within a multiprocessor system, thereby conserving energy throughout the multiprocessor system. The extent of power conversation enabled by the inventive principles disclosed herein is illustrated in FIG. 10 and is discussed in the following.

FIG. 10 is a chart illustrating respective levels of power conservation available employing conventional and preferred-embodiment approaches to processor cooperation in a multiprocessor system. FIG. 10 includes four basic portions, two of which illustrate power consumption levels of various processors over a common time period. A first portion 1010 shows processor states (idle, waiting, or running) for four processors: 102C, 102E, 102D, and 102F over the common time period. It is noted that processors 102C and 102D preferably form a processor pair with processor 102C being the master processor, and processor 102D being the slave processor. Likewise, processors 102E and 102F are preferably paired, with processor 102E being the master processor, and processor 102F being the slave processor.

A second portion 1020 of the chart illustrates the operating modes of four preferred-embodiment processors over the common time period. A third portion 1030 shows the power consumption over the common time period of the preferred-embodiment processors. A fourth portion 1040 shows power consumption among four conventional processors over the common time period.

Four time segments are presented in portion 1010 of FIG. 10. In the first segment, all four processors are in running state 704 and have tasks to perform. In the second segment, all processors except processor 102D are in running state 704, and processor 102D is in waiting state 706, having no task to perform. In the third segment, processors 102C and 102E are in running state 706, and processors 102D and 102F are in waiting state 706. In the fourth segment, processors 102C and 102E are in running state 704 for a portion of the segment and in idle state 702 for another portion of the segment, processor 102D is in running state 704, and processor 102F is in waiting state 706.

Chart portion 1020 indicates that in segment 1, all four preferred-embodiment processors are in normal mode. Consistent with this fact, it may be seen that the power consumption levels of the four conventional processors, as shown in chart portion 1040, and the power consumption levels of the four preferred-embodiment processors, as shown in chart portion 1030, are substantially the same.

In the second time segment, processor 102D is in the waiting state 706, while the other processors are in running state 704. Power consumption among the conventional processors 1040 indicates only a small reduction in power consumption in processor 102D for the second segment in comparison with the first time segment. In contrast, power consumption among the preferred-embodiment processors indicates a substantial reduction in power consumption in both processors 102C and 102D. It is noted that both processors 102C and 102D are in low-power mode (see chart portion 1020) during the second time segment. Preferably, the conclusion of task 3 in processor 102D allows the 102C-102D processor pair to share processing tasks, thereby allowing both processor 102C and processor 102D to operate in a low-power mode. The extent of power consumption reduction shown for processor 102C and processor 102D in chart portion 1030 may correspond to a condition in which both operating frequency reduction and supply voltage reduction are in effect for the 102C-102D processor pair.

In the third time segment, processors 102D and 102F are in waiting state 706, and processors 102C and 102F are in running state 704. Power consumption among the conventional processors 1040 indicates a modest reduction in power consumption for processors 102D and 102F but no power consumption reduction for processors 102C and 102E. It is noted that no power conservation is present among the conventional processors for processors 102C and 102E because no change in the operating mode occurs for these processors as a consequence of the waiting state 706 of processors 102D and 102F.

In contrast, power consumption among the preferred-embodiment processors 1030 indicates extensive power consumption reduction among all four processors. This increased extent of power conservation occurs because all four processors are able to operate in the low-power mode. The low-power mode is available because each of the processor pairs (102C-102D and 102E-102F) includes one processor in running state 704 and another in waiting state 706, thereby providing the needed conditions for low-power mode operation for both processor pairs.

Various factors enabling the preferred-embodiment processors to consume less power than do conventional processors have been discussed above. These same factors apply to the remainder of the chart of FIG. 10. Thus, for the sake of brevity, a detailed discussion of additional segments of the time period illustrated in FIG. 10 is not provided herein.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system is preferably able to complete tasks within a short and predictable time period.

To this end, and in accordance with this computer architecture, all processors of a multi-processor computing system are preferably constructed from a common computing module (or cell). This common computing module preferably has a consistent structure and preferably employs the same instruction set architecture throughout. The multi-processor computer system can be formed of one or more clients, servers, PCs, mobile computers, game machines, PDAs, set top boxes, appliances, digital televisions and other devices using computer processors.

One or more of the computer systems may also be members of a network if desired. The consistent modular structure preferably enables efficient, high speed processing of applications and data by the multi-processing computer system, and if a network is employed, the rapid transmission of applications and data over the network. This structure also simplifies the building of members of the network of various sizes, preferably enhances the processing power of each of the members and of the , and preferably facilitates the preparation of applications for processing by these members.

With reference to FIG. 11, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsenide, gallium aluminum arsenide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular-structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

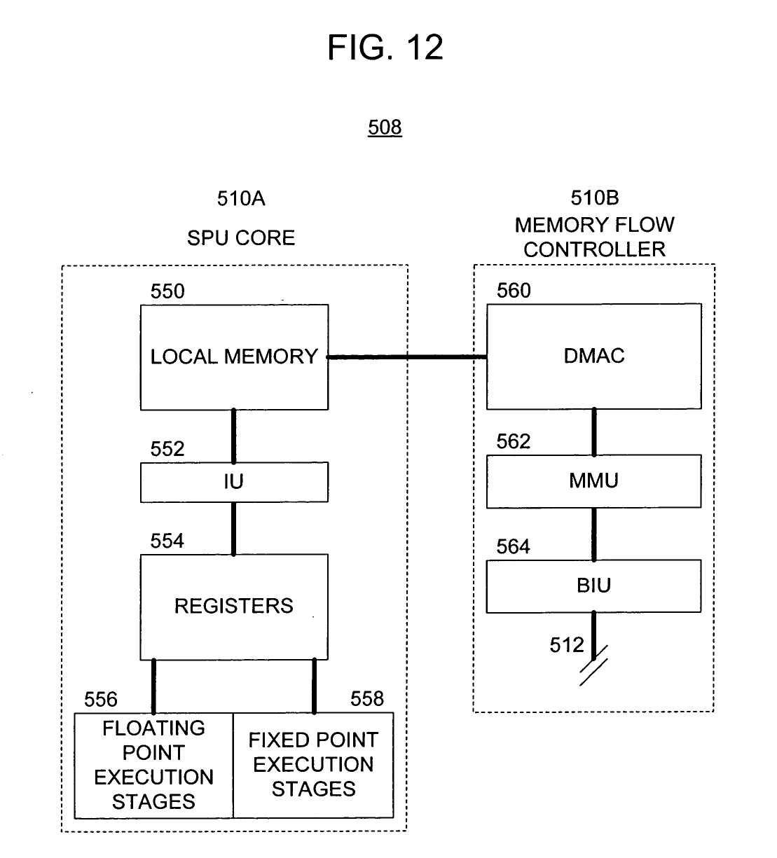

FIG. 12 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro--operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 264 bytes of effective address space with 4K-, 64K-, 1M-, and 16M- byte page sizes and 256MB segment sizes. Preferably, the MMU 562 is operable to support up to 265 bytes of virtual memory, and 242 bytes (4 TeraBytes) of physical memory for DMA commands. The hardware of the MMU 562 may include an 8-entry, fully associative SLB, a 256-entry, 4way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal.- commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

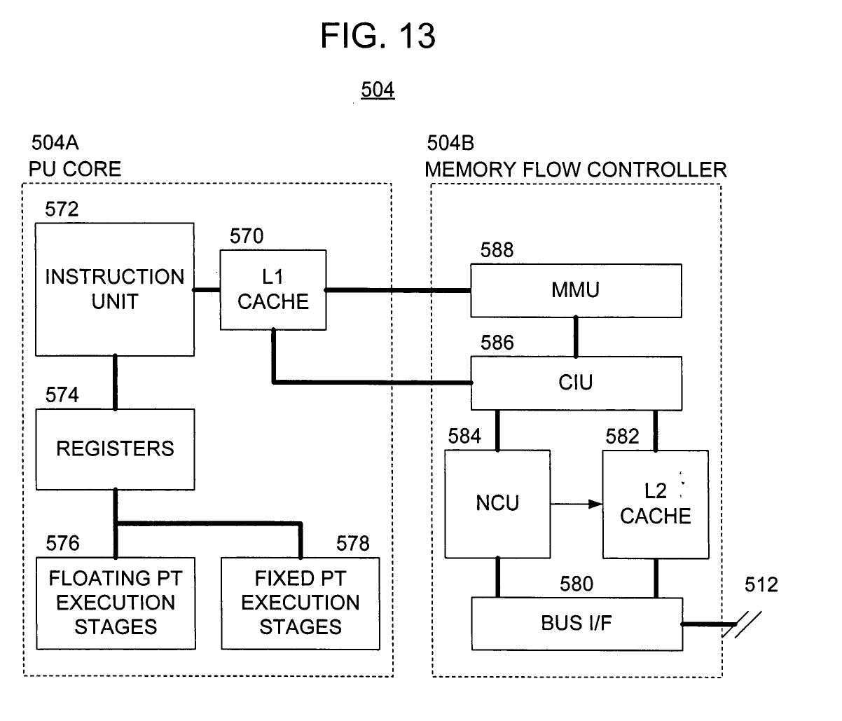

FIG. 13 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128KB.

The L2 cache memory 582 (and supporting hardware logic) is preferably designed to cache 512KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
issuing a plurality of instructions in a processing pipeline of a first processor within a multiprocessor system;
determining whether a second processor in said multiprocessor system is in at least one of a running state and a waiting state; and
transferring at least one of said instructions to execution stages of a processing pipeline of said second processor and bypassing at least one earlier stage of said processing pipeline of said second processor, when said second processor is in said waiting state.

2. The method of claim 1 wherein said bypassing comprises bypassing at least one of a fetch stage, a decode stage, and an issue stage of said processing pipeline of said second processor.

3. The method of claim 2 further comprising: selecting, within said processing pipeline of said second processor, between receiving instructions issued from said first processor or receiving instructions issued from said processing pipeline of said second processor.

4. The method of claim 1 further comprising: generating execution stage results by executing said transferred instructions in said second processor.

5. The method of claim 4 further comprising:
returning said execution stage results to said first processor.

6. The method of claim 4 further comprising: receiving said execution stage results into said register file of said processing pipeline of said first processor.

7. The method of claim 1 wherein said transferring comprises:
transferring said instructions only if said first processor is in a running state.

8. The method of claim 1 further comprising:
executing instructions in said first processor concurrently with executing said transferred instructions in said second processor.

9. The method of claim 8 further comprising reducing an operating frequency of at least a portion of said first processor and of at least a portion of said second processor during said concurrent execution.

10. The method of claim 9 wherein said reducing comprises reducing said operating frequency of said first and second processors by about 50% during said concurrent execution.

11. The method of claim 9 wherein at least one of:
said portion of said first processor includes a register file and execution stages of said processing pipeline of said first processor; and
said portion of said second processor includes said execution stages of said processing pipeline of said second processor.

12. The method of claim 1 further comprising:
transitioning from said running state to said waiting state in a given one of said processors when no instructions remain in said pipeline of said given processor.

13. The method of claim 11 further comprising:
transitioning from said waiting state to said running state in a given one of said first and second processors when at least one of:
a) at least one instruction arrives within a pipeline of said given processor; and
b) at least one instruction is transferred to said given processor from the other processor.

14. The method of claim 1 further comprising initiating said determining and said transferring by a processor unit (PU) of said multiprocessor system.

15. A multiprocessor system, comprising:
a first processor including a pipeline having at least an instruction issue stage for issuing a plurality of instructions;
a second processor including a pipeline having at least an execution stage and at least one earlier stage;
a first communication link coupled between said first and second processors such that at least one of said instructions may bypass said at least one earlier stage for execution in said execution stage of said second processor when said second processor is in a waiting state.

16. The multiprocessor system of claim 15 further comprising:
a second communication link coupled between said first and second processors such that execution stage results generated in said second processor may bypass a later stage of said pipeline of said second processor when said second processor is in said waiting state.

17. The multiprocessor system of claim 15 wherein said first communication link enables said at least one instruction to bypass at least one of a fetch stage, a decode stage, and an issue stage of said processing pipeline of said second processor.

18. The multiprocessor system of claim 15 wherein said multiprocessor system is operable to select, within said processing pipeline of said second processor, between receiving instructions issued from said first processor or receiving instructions issued from said processing pipeline of said second processor.

19. The multiprocessor system of claim. 15 wherein said multiprocessor system is operable to generate execution stage results in said second processor by executing said at least one instruction.

20. The multiprocessor system of claim 19 wherein said multiprocessor system is operable to return said execution stage results to said first processor.

21. The multiprocessor system of claim 20 wherein said multiprocessor system is operable to receive said execution stage results into a register file of said processing pipeline of said first processor.

22. The multiprocessor system of claim 15 wherein said multiprocessor system is operable to enable said at least one instruction to bypass said earlier stage of said pipeline of said second processor only when said first processor is in a running state.

23. The multiprocessor of claim 15 wherein said multiprocessor system is operable to execute instructions in said first processor concurrently with said execution in said second processor of said at least one instruction.

24. The multiprocessor of claim 23 wherein said multiprocessor system is operable to reduce an operating frequency of at least a portion of said first processor and of at least a portion of said second processor during said concurrent execution.

25. The multiprocessor system of claim 24 wherein said reducing comprises reducing said operating frequency of said first and second processors by about 50% during said concurrent execution.

26. The multiprocessor system of claim 24 wherein at least one of:
said portion of said first processor includes a register file and execution stages of said processing pipeline of said first processor; and
said portion of said second processor includes said execution stage of said processing pipeline of said second processor.

27. The multiprocessor system of claim 15 wherein said first communication link between said first and second processors is established during a manufacture of said multiprocessor system.

28. The multiprocessor system of claim 15 wherein said first communication link extends from said instruction issue stage of said first processor to said execution stage of said second processor.

29. The multiprocessor system of claim 16 wherein said second communication link extends from said execution stage of said second processor to a register file of said first processor.

30. The multiprocessor system of claim 16 further comprising:
an instruction selection multiplexer, in said second processor, disposed between said first communication link and said execution stage.

31. The multiprocessor system of claim 30 wherein said instruction selection multiplexer is operable to select between instructions issued from said second processor and instructions transferred along said first communication link.

32. The multiprocessor system of claim 15 wherein said execution stage of said second processor comprises an instruction buffer and at least one execution unit.

33. The multiprocessor system of claim 16 further comprising:
an execution results multiplexer, in said first processor, disposed between second communication link and a register file of said first processor.

34. The multiprocessor system of claim 33 wherein said execution results multiplexer is operable to select between execution stage results generated in said first processor and said execution stage results generated in said second processor.
